(19) United States
(12) Patent Application Publication
(10) Pub. No.: US 2010/0173181 A1
(43) Pub. Date: Jul. 8, 2010

(54) BATTERY SYSTEM WITH EXHAUST DUCTS

(76) Inventor: Wataru OKADA, Kobe City (JP)

Correspondence Address: WENDEROTH, LIND & PONACK, L.L.P., Suite 800, 2033 "K" Street, N.W., Washington, DC, 20006, US

(21) Appl. No.: 12/608,356

(22) Filed: Oct. 29, 2009

(30) Foreign Application Priority Data
Oct. 31, 2008 (JP) 2008-281121

(51) Int. Cl. H01M 2/12

(52) U.S. Cl. 429/53

(57) ABSTRACT

The battery system is provided with battery blocks 2 that connect a plurality of battery cells 1 having gas exhaust valves 11; and with hollow exhaust ducts 20 that connect to the gas exhaust valve 11 gas exhaust opening 12 of each battery cell 1 that makes up the battery blocks 2, and that exhaust gas discharged from the gas exhaust openings 12 to the outside. The exhaust ducts 20 are made of plastic with embedded metal lines 21 that extend in the lengthwise direction.

### BACKGROUND OF THE INVENTION

1. Field of the Invention

The present invention relates to a battery system used primarily as a car power source to supply electric power to a motor that drives a vehicle such as a hybrid car or electric automobile, and in particular relates to a battery system that discharges gas from battery cell gas exhaust valves to the outside through exhaust ducts.

2. Description of the Related Art

In a battery system provided with many battery cells, high output voltage can be attained by connecting the battery cells in series. This battery system can be used in an application, such as a hybrid car power source apparatus, that charges and discharges batteries with high currents. In this battery system, batteries are discharged with extremely large currents during vehicle acceleration, and are charged with correspondingly high currents under conditions such as regenerative braking. To insure safe operation, battery cells are provided with gas exhaust valves to prevent damage due to abnormal rise in internal pressure induced by over-charging or over-discharging. A gas exhaust valve opens to discharge gas when battery cell internal pressure rises abnormally. In a battery system provided with many battery cells, it is important to quickly exhaust gas discharged from the battery cells to the outside. In particular, for rectangular batteries that use non-aqueous electrolytes such as lithium ion batteries, it is important to quickly exhaust discharged gas. To achieve this, a battery system has been developed that connects exhaust tubes to the exhaust openings of battery cell gas exhaust valves. (Refer to Japanese Patent Application Disclosure 2007-157633.)

The battery system cited in Japanese Patent Application Disclosure 2007-157633 connects exhaust tubes to the gas exhaust openings of rectangular batteries. This battery system exhausts gas discharged from the rectangular batteries to the outside via the exhaust tubes. A battery system of this configuration can be made light-weight by making the exhaust tubes from plastic. However, because the electrical resistance of plastic exhaust tubes is extremely high, static electricity makes it easy for foreign objects such as dust and dirt to adhere to the plastic exhaust tubes. Further, attached dust can absorb moisture and cause leakage currents. In particular, if attached dust absorbs moisture and causes leakage currents, it takes time for the moisture to evaporate, and this has the drawback that time is required to correct a leakage condition. Still further, over a long-time use, static electricity causes dust and dirt accumulation on the plastic exhaust tubes, and this has the drawback that leakage currents easily develop due to the large quantities of accumulated dust and dirt.

The present invention was developed with the object of further correcting these drawbacks. Thus, it is a primary object of the present invention to provide a battery system with plastic exhaust ducts that can prevent dust and dirt attachment due to static electricity, and can effectively prevent leakage currents due to moisture absorption by dust and dirt.

### SUMMARY OF THE INVENTION

The battery system of the present invention is provided with battery blocks 2 that connect a plurality of battery cells 1 having gas exhaust valves 11; and with hollow exhaust ducts 20, 50, 70 that connect to the gas exhaust valve 11 gas exhaust opening 12 of each battery cell 1 that makes up the battery blocks 2, and exhaust gas discharged from the gas exhaust openings 12 to the outside. The exhaust ducts 20, 50, 70 are made of plastic with metal lines 21, 51, 71 that extend in the lengthwise direction embedded in the plastic.

This battery system prevents dust and dirt attachment due to static electricity via metal lines embedded in, and extending in the lengthwise direction of the plastic exhaust ducts. This is because the embedded metal lines reduce the electrical resistance of exhaust ducts, which are made of insulating plastic. Therefore, moisture absorption by dust and dirt attached by static electricity can be avoided, and leakage currents due to attached dust and dirt can be effectively prevented. Further, in this battery system, metal lines embedded in, and extending in the lengthwise direction of the plastic exhaust ducts achieve the effect of reinforcing the plastic exhaust ducts. This structure has the characteristic that while fabricating the exhaust ducts from light-weight plastic, sufficient strength can be realized.

The battery system of the present invention has battery cells 1 that are rectangular battery cells 1A, and those rectangular battery cells 1A are stacked with their perimeter surfaces 10, which are provided with gas exhaust openings 12, aligned in a single plane to form battery blocks 2. Rectangular battery cells 1A that make up a battery block 2 have an exhaust duct 20, 50, 70 disposed on their perimeter surfaces 10 that are provided with gas exhaust openings 12. This allows the exhaust duct 20, 50, 70 to connect with the gas exhaust opening 12 of each rectangular battery cell 1A.

This battery system, which is configured with exhaust ducts disposed on rectangular battery cell perimeter surfaces, can connect a plurality of rectangular battery cell gas exhaust openings to a single exhaust duct. Consequently, many rectangular battery cell gas exhaust openings can be connected to exhaust ducts with a simple structure.

The battery system of the present invention has battery cells 1 that are rectangular battery cells 1A, and electrode terminals can be established at both ends of a rectangular battery cell 1A perimeter surface 10, which is provided with a gas exhaust opening 12. In this battery system, by effectively preventing static electricity induced dust and dirt attachment to the exhaust ducts, which are disposed in the vicinity of the electrode terminals, electrode terminal leakage currents can be effectively prevented.

In the battery system of the present invention, metal lines 21, 51, 71 can be embedded in both side-walls 20A, 50A, 70A on opposite sides of an exhaust duct 20, 50, 70. This battery system can symmetrically reinforce both sides of an exhaust duct via metal lines embedded in both side-walls. In addition, metal lines embedded in both sides of an exhaust duct allow further reduction in the electrical resistance of the plastic exhaust duct, and enable more effective prevention of dust and dirt attachment due to static electricity.

In the battery system of the present invention, metal lines 21, 51, 71 can be embedded in exhaust ducts 20, 50, 70 by insertion molding. In this battery system, exhaust ducts with metal lines insertion molded inside can be manufactured inexpensively in quantity. In addition, metal lines can be embedded in a robust fashion that does not easily come apart, and the exhaust duct can be strongly reinforced by the metal lines.

In the battery system of the present invention, the metal lines 21, 51, 71 can be connected to the ground line. By connecting the metal lines to the ground line of this battery system, static electricity can be removed from the metal lines to the ground line and dust and dirt attachment due to static electricity can be more effectively prevented. Further, by connecting the metal lines to the ground line, battery block perimeter surfaces can also be electrically shielded.

The battery system of the present invention is provided with a metal external case 30 to house the battery blocks 2. Nuts 27 can be mounted in the exhaust ducts 20, 50, 70 to accept bolts 37 for attaching the external case 30, and the metal lines 21, 51, 71 can be connected to the nuts 27 to electrically connect the metal lines 21, 51, 71 to the external case 30. In this battery system, metal lines embedded in the exhaust ducts can be connected to the external case by attaching the external case with bolts that fasten to the nuts. As a result, the metal lines can be electrically connected to the external case without special-purpose connecting lines simply by attaching the external case, and dust and dirt attachment due to static electricity can be effectively prevented.

The battery system of the present invention can be provided with circuit boards 6 that connect to the battery blocks 2, and the exhaust ducts 20 with embedded metal lines 21 can be disposed between the circuit boards 6 and the battery blocks 2. In this battery system, exhaust ducts with embedded metal lines can shield the circuit boards from the battery blocks. Consequently, this battery system has the characteristic that the circuit boards can be shielded from noise induced by high currents and pulse currents flowing in the battery blocks. The above and further objects of the present invention as well as the features thereof will become more apparent from the following detailed description to be made in conjunction with the accompanying drawings.

### BRIEF DESCRIPTION OF THE DRAWINGS

FIG. 1 is an oblique view of a battery system for an embodiment of the present invention;

FIG. 2 is an exploded oblique view of the battery system shown in FIG. 1;

FIG. 3 is an oblique view of the battery system shown in FIG. 1 with the external case removed;

FIG. 4 is an exploded oblique view of the battery system shown in FIG. 3;

FIG. 5 is an oblique view from below of the battery system shown in FIG. 4;

FIG. 6 is an enlarged vertical cross-section view of a pertinent part of the battery system shown in FIG. 1;

FIG. 7 is an oblique view of the exhaust ducts shown in FIG. 3;

FIG. 8 is a plan view of the exhaust ducts shown in FIG. 7;

FIG. 9 is a lateral cross-section view of the exhaust ducts shown in FIG. 6;

FIG. 10 is a cross-section view showing another exhaust duct example;

FIG. 11 is a cross-section view showing another exhaust duct example; and

FIG. 12 is an enlarged cross-section view of a pertinent part of a battery system for another embodiment of the present invention.

### DETAILED DESCRIPTION OF THE EMBODIMENT(S)

The battery system exemplified by the following embodiment is most appropriately used as a power source for an electric driven vehicle such as a hybrid car, which is driven by both an electric motor and an engine, or an electric automobile, which is driven by an electric motor only. However, it can be used in a vehicle other than a hybrid car or electric automobile, and it can also be used in applications that require large output other than electric vehicles.

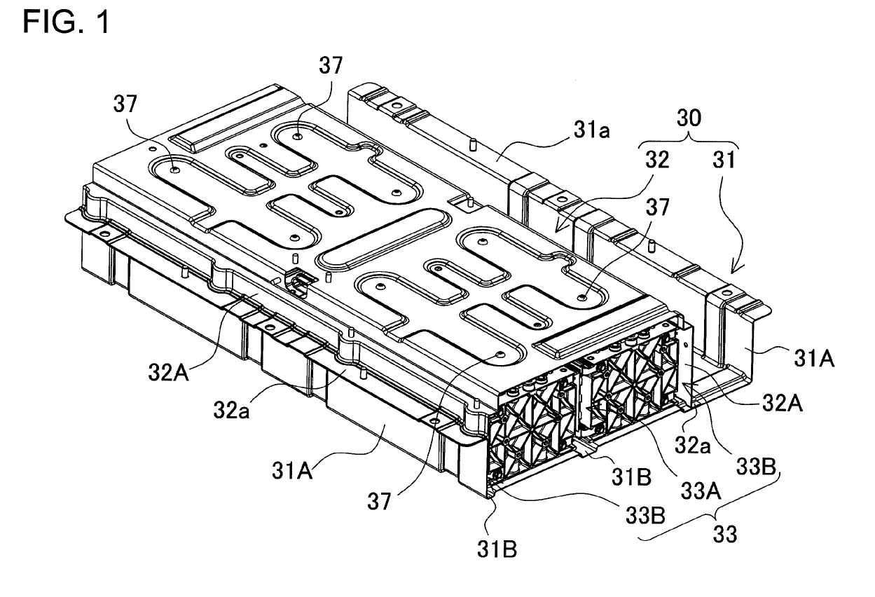

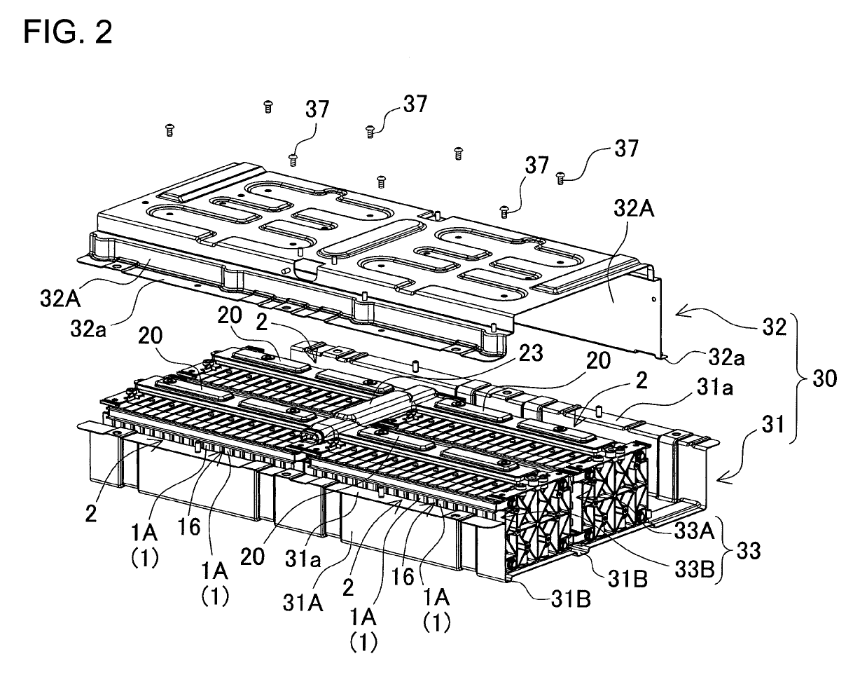

The battery system of FIGS. 1 and 2 is provided with battery blocks 2 that connect a plurality of battery cells 1 having gas exhaust valves 11; and with hollow exhaust ducts 20 that connect to the gas exhaust valve 11 gas exhaust opening 12 of each battery cell 1 that makes up the battery blocks 2, and exhaust gas discharged from the gas exhaust openings 12 to the outside. In the figures, battery blocks 2 with exhaust ducts 20 attached to their upper surfaces are housed in an external case 30.

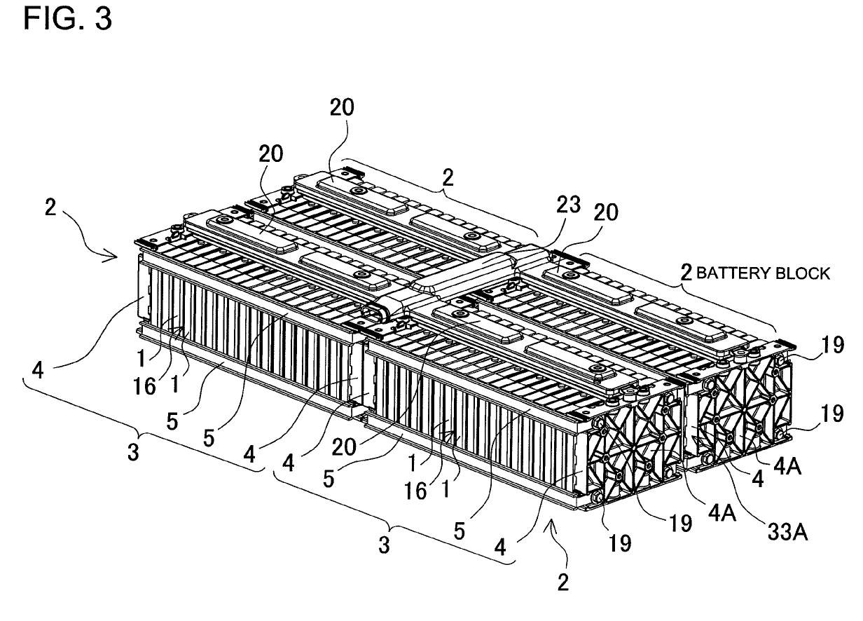

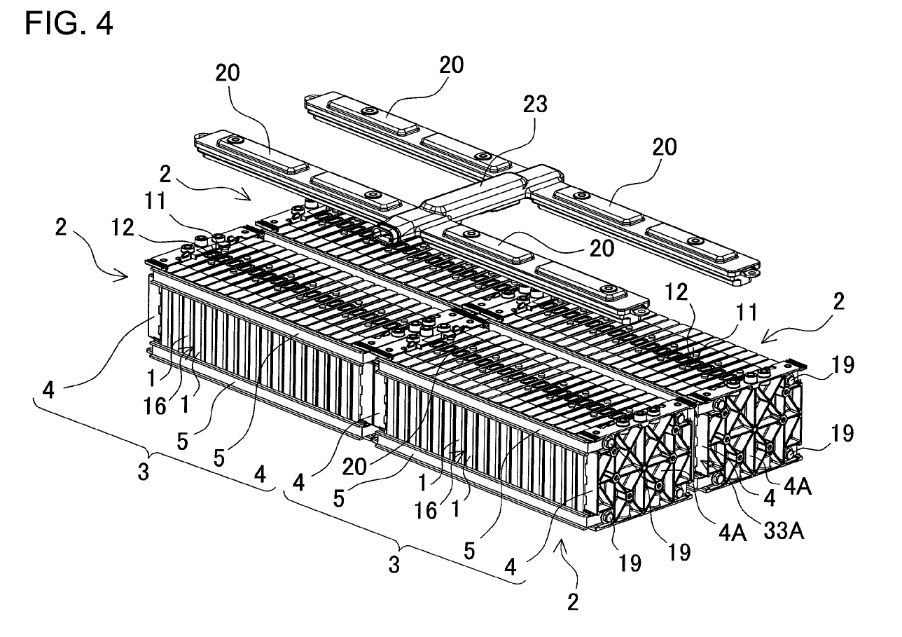

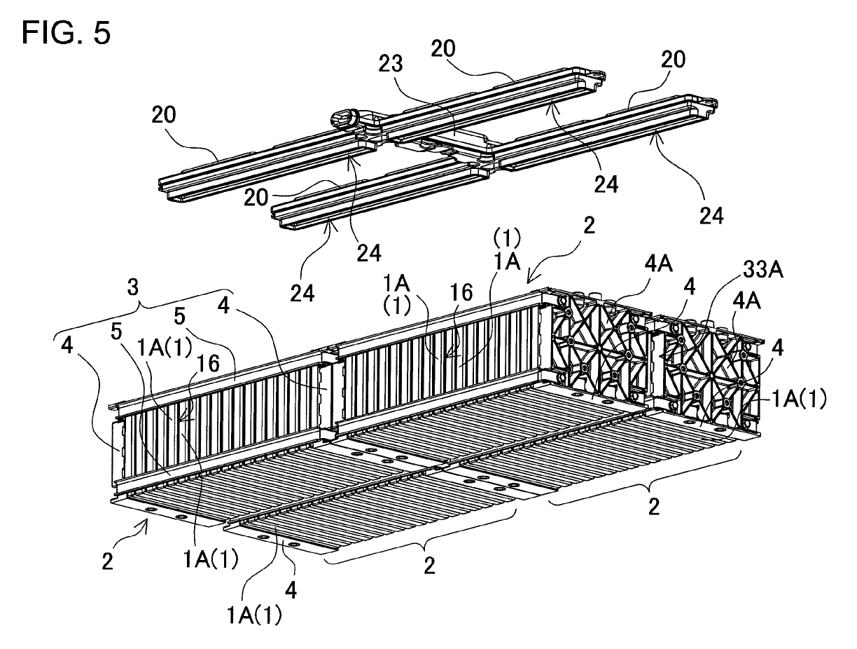

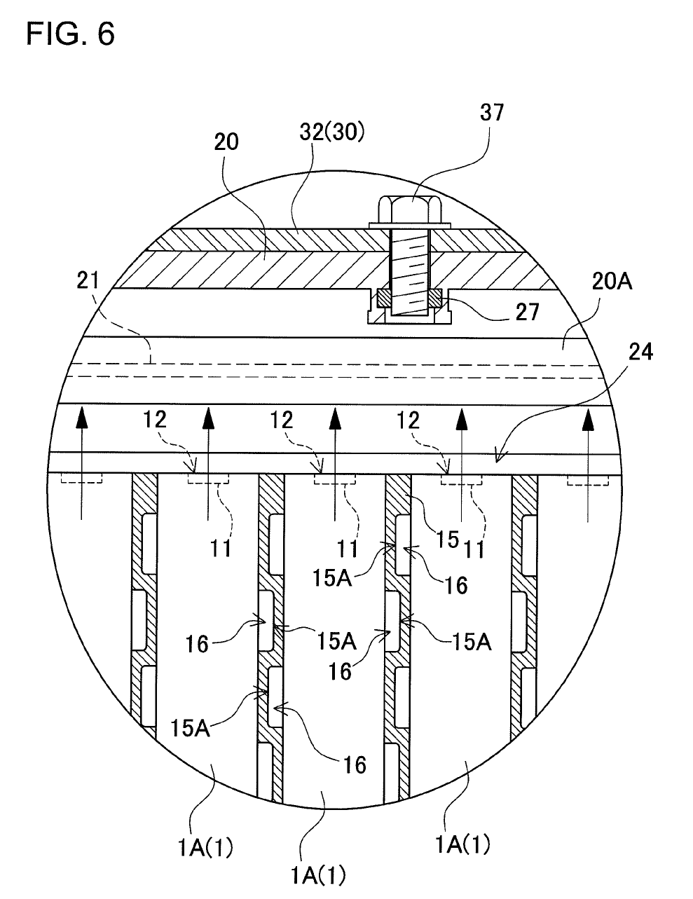

The battery blocks 2 of FIGS. 3-5 have rectangular battery cells 1A as battery cells 1, and a plurality of rectangular battery cells 1A are stacked to form a battery block 2. Battery holders 3 that retain the battery blocks 2 are attached outside the battery blocks 2. The battery system has a plurality of battery blocks 2, and the battery system of the figures has four battery blocks 2 arrayed in a single plane. As shown in FIG. 6, rectangular battery cells 1A are disposed with their perimeter surfaces 10, which are provided with gas exhaust openings 12, oriented in a single plane, and they are stacked with intervening insulating separators 15 to form a battery block 2. A hollow exhaust duct 20 is disposed in a manner that connects to the gas exhaust openings 12 of the rectangular battery cells 1A that make up a battery block 2, and this exhaust duct 20 exhausts gas discharged from those gas exhaust openings 12 to the outside. The rectangular battery cells 1A of the figures are stacked with their perimeter surfaces 10, which are provided with gas exhaust valves 11, as upper surfaces.

As shown in the figures, a rectangular battery cell 1A is wide compared to its thickness. These rectangular batteries cells 1A, which are thinner than they are wide, are stacked in the direction of the thin dimension to form a battery block 2. The rectangular battery cells 1A are lithium-ion rechargeable batteries. However, the rectangular battery cells can also be rechargeable batteries such as nickel-hydride batteries or nickel-cadmium batteries. The rectangular battery cells 1A of the figures have rectangular shapes with wide surfaces on both sides, and those side surfaces are stacked against one another to form a battery block 2. The rectangular battery cells 1A of the figures are provided with gas exhaust valve 11 gas exhaust openings 12 in the center region of their upper surfaces. Although not illustrated, each rectangular battery cell 1A is provided with positive and negative electrode terminals 13 protruding from both ends of the upper surface.

The gas exhaust valve 11 opens to prevent excessive internal pressure rise when the internal pressure of the rectangular battery cell 1A becomes greater than a set pressure. The gas exhaust valve 11 houses a valve mechanism (not illustrated) that closes off the gas exhaust opening 12. The valve mechanism has a membrane that breaks at a set pressure, or it is a valve with a flexible component that presses against a valve seat and opens at a set pressure. When the gas exhaust valve 11 is opened, the interior of the rectangular battery cell 1A is opened to the outside through the gas exhaust opening 12, and internal gas is exhausted to prevent internal pressure build-up.

Although not illustrated, adjacent rectangular battery cells 1A have their positive and negative electrode terminals connected in series. The battery system has positive and negative electrode terminals of adjacent rectangular battery cells 1A connected in series via bus-bars. A battery system with rectangular battery cells connected in series increases the output voltage and allows large output. However, the battery system can also have adjacent rectangular battery cells connected in parallel.

As shown in FIG. 6, a battery block 2 has insulating separators 15 sandwiched between stacked rectangular battery cells 1A. The insulating separators 15 insulate adjacent rectangular battery cells 1A. Although not illustrated, an insulating separator 15 has a shape that fits rectangular battery cells 1A in fixed positions on both sides, and allows adjacent rectangular battery cells 1A to be stacked without shifting position. Rectangular battery cells 1A stacked in an insulating manner with insulating separators 15 can have outer cases made of metal such as aluminum. In a configuration that sandwiches insulating separators 15 between rectangular battery cells 1A, the insulating separators 15 are made of material such as plastic with low thermal conductivity, and this also results in effectively preventing thermal runaway of adjacent rectangular battery cells 1A.

Insulating separators 15 stacked between rectangular battery cells 1A are provided with cooling gaps 16 between the insulating separators 15 and the rectangular battery cells 1A to pass a cooling gas such as air to effectively cool the rectangular battery cells 1A. The insulating separators 15 of FIG. 6 are provided with grooves 15A in their surfaces opposite the rectangular battery cells 1A that extend to the edges on both sides and establish cooling gaps 16 between the insulating separators 15 and the rectangular battery cells 1A. The insulating separators 15 are provided with a plurality of grooves 15A having parallel orientation and disposed at given intervals. The insulating separators 15 are provided with grooves 15A on both sides to establish cooling gaps 16 between the insulating separators 15 and adjacent rectangular battery cells 1A. This structure has the characteristic that rectangular battery cells 1A on both sides of an insulating separator 15 can be effectively cooled by cooling gaps 16 formed on both sides of the insulating separator 15. However, grooves can also be provided on only one side of an insulating separator to establish cooling gaps between rectangular battery cells 1A and insulating separators. The cooling gaps 16 are established extending in a horizontal direction and opening on the left and right sides of a battery block 2. Ventilating air passed through the cooling gaps 16 efficiently cools rectangular battery cell 1A outer cases directly. This configuration has the characteristic that rectangular battery cells 1A can be efficiently cooled while preventing rectangular battery cell 1A thermal runaway.

The battery holder 3, which retains rectangular battery cells 1A in a stacked configuration as a battery block 2, is provided with a pair of endplates 4 that sandwiches the battery block 2 from both ends, and connecting rails 5 connected at both ends or mid-regions to the endplates 4.

The endplates 4 have a rectangular shape with the same dimensions and shape as the outline of the rectangular battery cells 1A, and the endplates 4 hold the stacked battery block 2 from both ends. An endplate 4 is made of plastic or metal and is provided with reinforcing ribs 4A extending vertically and horizontally on the outer surface, which is formed as a single piece with the endplate 4. Endplates can be reinforced with reinforcing metal pieces. Further, connecting rails can be connected to those reinforcing metal pieces. This configuration has the characteristic that endplates reinforced with reinforcing metal pieces have a robust structure, and connecting rails can be solidly connected to the endplates. In particular, this configuration has the characteristic that it can make molded plastic endplates inherently strong. However, endplates do not always need to be reinforced with reinforcing metal pieces. For example, endplates can also be made of metal with no reinforcing metal pieces, and connecting rails can be directly connected to those endplates.

The connecting rails 5 are made of metal such as steel and attach at both ends or mid-regions to endplates 4 via set screws 19.

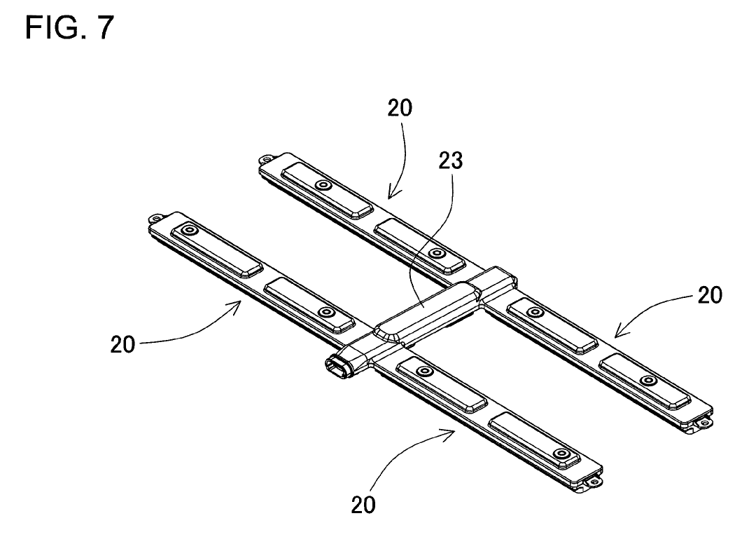

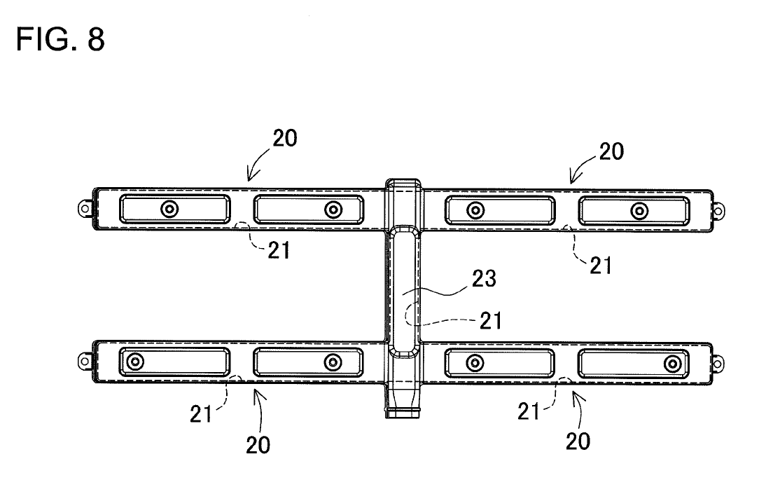

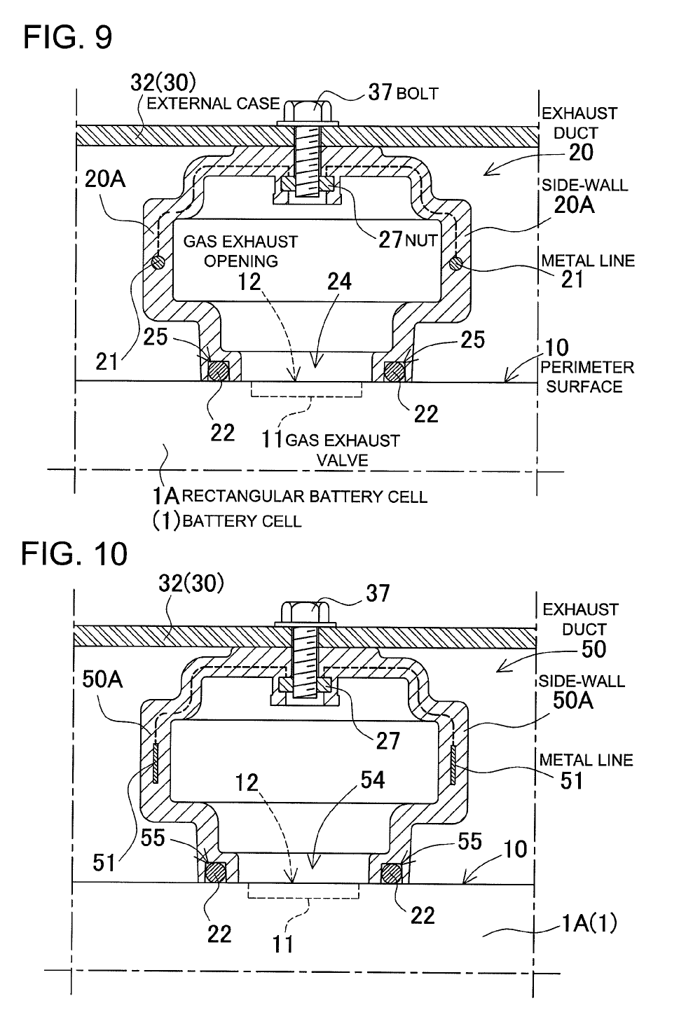

The battery system shown in FIGS. 2-6 has an exhaust duct 20 disposed on the upper surface of each battery block 2. FIGS. 7 and 8 show an oblique view and a plan view of the exhaust ducts 20, and FIG. 9 shows a cross-section view of an exhaust duct 20. Exhaust ducts 20 are formed from insulating plastic. The insulating plastic is a plastic such as nylon resin or epoxy resin. As shown in the cross-section of FIG. 9, the plastic exhaust ducts 20 have metal lines 21 embedded in the plastic extending in the lengthwise direction of the exhaust ducts 20. The exhaust ducts 20 of the figures have metal lines 21 embedded in both side-walls 20A on opposing sides of an exhaust duct 20. As shown by the broken lines of FIG. 8, these exhaust ducts 20 have metal lines 21 embedded along their perimeters. A configuration with metal lines 21 embedded in both side-walls 20A along the perimeters of the exhaust ducts 20 can reduce electrical resistance and effectively prevent dust and dirt attachment due to static electricity while reinforcing the exhaust ducts 20. However, although not illustrated, a metal line can be embedded extending in the lengthwise direction of an exhaust duct in only one side-wall, in the upper panel, or in the lower panel, and also prevent dust and dirt attachment due to static electricity.

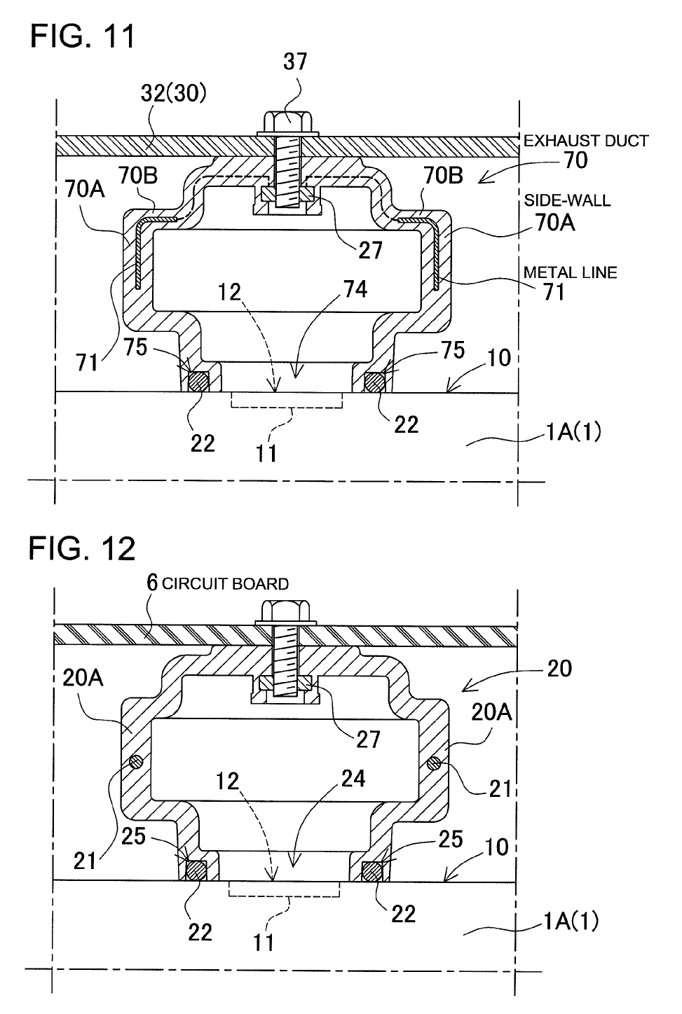

The exhaust duct 20 of FIG. 9 has embedded metal lines 21 that are metal wires with circular cross-sections. As shown in FIG. 10, the metal lines embedded in the exhaust ducts can be shaped as flat-plates. Flat-plate metal lines 51 can be embedded in exhaust duct 50 side-walls 50A as shown in FIG. 10; or, although not illustrated, they can also be embedded in the upper panel or lower panel of an exhaust duct. In addition, as shown in FIG. 11, metal lines can have L-shaped cross-sections. As shown in FIG. 11, these metal lines 71 can span across the side-walls 70A and the upper panel 70B; or, although not illustrated, they can be embedded to span across the side-walls and the lower panel.

The metal lines 21, 51, 71 can be embedded by insertion molding during the process of molding the plastic exhaust ducts 20, 50, 70. Metal lines 21, 51, 71 embedded in exhaust ducts 20, 50, 70 by insertion molding are solidly and robustly embedded and can effectively reinforce the exhaust ducts 20, 50, 70. However, the metal lines can also be embedded in pre-formed plastic exhaust ducts by follow-up processing. In follow-up processing, exhaust duct plastic can be heated to melting temperature and metal lines can be pressed into the plastic exhaust ducts. In this processing, a section of the embedded metal lines is left exposed outside the exhaust duct surfaces. Metal line left exposed outside the exhaust duct surfaces can be connected to the ground line to more effectively prevent dust and dirt attachment to the exhaust ducts due to static electricity. Further, metal lines embedded in plastic exhaust ducts by insertion molding can also have a section left exposed outside the exhaust ducts, and that exposed section can be connected to the ground line.

Further, the cross-sections of FIGS. 9-11 show nuts 27 mounted in the exhaust ducts 20, 50, 70 that mate with bolts 37 that attach the external case 30. The metal lines 21, 51, 71 are connected to those nuts 27. In these exhaust ducts 20, 50, 70, metal lines 21, 51, 71 can be connected to the external case 30 via the bolts 37 that attach the external case 30. In this battery system, by connecting the external case 30 to the ground line, metal lines 21, 51, 71 are connected to the ground line, and dust and dirt attachment to the exhaust ducts 20, 50, 70 due to static electricity can be more reliably prevented.

The battery system shown in the cross-section view of FIG. 12 is provided with a circuit board 6 connected to a battery block 2, and an exhaust duct 20 with embedded metal lines 21 is disposed between the circuit board 6 and the battery block 2. The circuit board 6 has surface mounted electronic components that implement circuits that protect the rectangular battery cells 1A. This circuit board 6 is connected to each rectangular battery cell 1A and has circuits including a voltage detection circuit to measure cell voltage and a temperature detection circuit to detect rectangular battery cell 1A temperature. The circuit board 6 detects cell voltage and controls charging and discharging to prevent rectangular battery cell 1A over-charging and over-discharging, or it controls charging and discharging to prevent abnormal rise in rectangular battery cell 1A temperature. Since an exhaust duct 20 with embedded metal lines 21 is disposed between the circuit board 6 and the battery block 2 of this battery system, the circuit board 6 can be shielded from the battery block 2 by the exhaust duct 20 with embedded metal lines 21. A battery block 2 is charged and discharged with high currents, and in particular, is charged and discharged with high current pulses. As a result, a battery block 2 radiates noise with pulse characteristics. The metal lines 21 embedded in the exhaust duct 20 are disposed between the circuit board 6 and the battery block 2, and this has the characteristic that the circuit board 6 can be shielded from noise pulses radiated from the battery block 2 and circuit board 6 malfunction due to induced noise can be prevented. In particular, by connecting exhaust duct 20 metal lines 21 to the ground line, noise induced from the battery block 2 can be more effectively prevented.

Exhaust ducts 20, 50, 70 are provided with connecting openings 24, 54, 74 to connect with the gas exhaust opening 12 of each rectangular battery cell 1A, and these connecting openings 24, 54, 74 are connected with the gas exhaust openings 12. The battery system of the figures has gaskets 22 disposed around connecting opening 24, 54, 74 perimeters. The gaskets 22 are O-rings that are sandwiched between the exhaust ducts 20, 50, 70 and rectangular battery cell 1A perimeter surfaces 10. The O-rings enable connection of the connecting openings 24, 54, 74 and gas exhaust openings 12 with a structure that does not leak gas. The bottom surface of an exhaust duct 20, 50, 70, which is the surface opposite rectangular battery cell 1A perimeter surfaces 10, is provided with a gasket groove 25, 55, 75 to restrain the position of the gasket 22. The O-ring, which is the gasket 22, is aligned in the gasket groove 25, 55, 75 and put in tight contact with rectangular battery cell 1A perimeter surfaces 10. This configuration allows gas ejected from rectangular battery cell 1A gas exhaust openings 12 to flow into the exhaust duct 20 without leaking for discharge outside the battery system. However, it is not always necessary to dispose gaskets between the exhaust ducts and the rectangular battery cells. This is because the connecting openings 24, 54, 74 can be connected to gas exhaust openings 12 without leaking by tight contact between opposing surfaces of the exhaust ducts 20, 50, 70 and rectangular battery cells 1A.

The battery system of FIGS. 2-5 has four battery blocks 2 arrayed in two rows, and two rows of exhaust ducts 20 are disposed on the upper surfaces of the battery block 2. The two rows of exhaust ducts 20 are joined at the center of the battery system by a connecting duct 23 that joins the exhaust ducts 20 and connecting duct 23 in an H-configuration. The connecting duct 23 located at the center of the battery system discharges gas flowing in from each exhaust duct 20 to the outside. Consequently, an external duct (not illustrated) that exhausts gas to the outside is connected to one end of the connecting duct 23. An exhaust duct 20 has one end open to connect with the connecting duct 23, and the other end is closed off. Gas discharged from a gas exhaust opening 12 flows into an exhaust duct 20 through the connecting opening 24 and is exhausted to the outside through the connecting duct 23. In the battery system described above, two rows of exhaust ducts 20 are connected at the center to exhaust gas to the outside. However, two rows of exhaust ducts 20 can also be connected at both ends to exhaust gas to the outside. Further, as shown by the broken lines in FIG. 8, metal lines 21 are embedded along the perimeter of the connecting duct 23 in both opposing side-walls. Metal lines 21 in the connecting duct 23 are connected to metal lines 21 in the exhaust ducts 20. This structure has the characteristic that it can reduce the electrical resistance of the connecting duct 23, can effectively prevent dust and dirt attachment due to static electricity, and can reinforce the connecting duct 23 with the metal lines 21.

The battery system shown in FIGS. 1 and 2 has battery blocks 2 housed in an external case 30. The external case 30 of the figures is made up of an upper case 32 and a lower case 31. The battery system has a plurality of battery blocks 2 arranged in rows and columns and mounted in the external case 30. The battery system shown in the exploded oblique view of FIG. 2 has two rows of two battery blocks 2 arranged in straight lines to dispose four battery blocks 2 on the lower case 31. The two rows of battery blocks 2 are disposed with separation to establish an air duct 33 between them.

The upper case 32 and lower case 31 are sheet metal formed in U-shapes. The upper case 32 and lower case 31 are made from sheet metal of the same thickness, or the lower case 31 is made from thicker sheet metal than the upper case 32. The upper case 32 and lower case 31 are provided with side-walls 32A, 31A that establish their U-shapes. In the battery system of the figures, the lateral width of the lower case 31 is greater than that of the upper case 32, and an electronic component case (not illustrated) can be disposed between a lower case 31 side-wall 31A and an upper case 32 side-wall 32A. The lower case 31 has a lateral width that is greater than the upper case 32 lateral width by the width of the electronic component case. Specifically, the lateral width of the lower case 31 is equal to the lateral width of the upper case 32 plus the width of the electronic component case.

As shown in FIG. 2, the lower case 31 side-wall 31A on the left side is attached to the upper case 32 side-wall 32A on the left side. The upper case 32 side-wall 32A on the right side is attached to the bottom section of the lower case 31, and divides the battery block 2 storage area from the electronic component case. The upper case 32 side-wall 32A on the right side is made taller than the side-wall 32A on the left side to enable attachment of its lower edge to the bottom section of the lower case 31. The edges of lateral extremities of both the upper case 32 and the lower case 31 are provided with outward bent flanges 32a, 31a for case attachment. Flanges 32a, 31a are attached by nuts (not illustrated) and bolts (not illustrated) that pass through the flanges 32a, 31a, or the flanges are attached by rivets to join the upper case 32 and the lower case 31.

In the battery system shown in FIG. 2, the lower case 31 is provided with side-walls 31A of approximately the same height on both sides. In the figures, the lower case 31 side-wall 31A on the left side is attached to the upper case 32 side-wall 32A on the left side. The lower case 31 side-wall 31A on the right side is not attached to the upper case 32 side-wall 32A, but rather is attached to an attachment plate (not illustrated) side-wall of the electronic component case, which is mounted on the upper case 32. The upper case 32 is also provided with side-walls 32A on both sides. In the figures, the upper case 32 side-wall 32A on the right side is longer than the side-wall 32A on the left side, the shorter side-wall 32A is attached to the lower case 31 side-wall 31A on the left side, and the longer side-wall 32A on the right side is attached to the bottom section of the lower case 31.

Although not illustrated, an electronic component case attachment plate is attached to the upper end of the right side-wall 32A of the upper case 32. The attachment plate is sheet metal formed in an L-shape and provided with a top plate and a side-wall on one side. The edge of the top plate of the attachment plate is attached to the upper edge of the upper case 32 side-wall 32A. A flange provided on the bottom edge of the attachment plate side-wall is attached to the flange 31 a provided on the upper edge of the lower case 31 side-wall 31A on the right side. Attachment plate flanges are attached to lower case 31 flanges 31 a to join the attachment plate and the lower case 31. In this external case 30 configuration, the side-wall 32A provided on the right side of the upper case 32 separates the battery block 2 storage area and the electronic component case.

The outer case 30, which is made up of the upper case 32 and the lower case 31, is made wider than the outer sides of the battery blocks 2 to allow room for air ducts 33. In the battery system of FIGS. 1 and 2, an air duct 33 is provided at the center between the two rows of battery blocks 2, and air ducts 33 are also provided between the outside of the battery blocks 2 and the side-walls 32A, 31A. In this battery system, either the center air duct 33A between the two rows of battery blocks 2 or the pair of side air ducts 33B on the outside of the battery blocks 2 is used as a cooling air supply duct, and the other duct or pair of ducts is used as an exhaust duct. Cooling air is passed through the cooling gaps 16 between battery cells 1 to cool the battery cells 1.

The battery system shown in FIG. 1 is provided with a side air duct 33B between an outer side (the right side in the figure) of the battery blocks 2 and an upper case 32 side-wall 32A. The electronic component case storage area is disposed outside the upper case 32 side-wall 32A, which is outside the side air duct 33B and forms a wall of the side air duct 33B. In this structure, a side air duct 33B and side-wall 32A are provided between electronic components (not illustrated) housed in the electronic component case and the battery blocks 2. In this configuration, the battery blocks 2 do not heat the electronic components, and detrimental effects on the electronic components due to heat generated by the battery blocks 2 can be prevented.

The open top of the center cooling duct 33A established between the two rows of battery blocks 2 is closed off by a cooling duct sealing plate (not illustrated), and the open bottom of the center cooling duct 33A is closed off by the lower case 31. The cooling duct sealing plate is a narrow metal plate that extends along the center cooling duct 33A established between the two battery block 2 rows. The cooling duct sealing plate is attached on both sides to battery blocks 2 to close off the open top of the center cooling duct 33A. The cooling duct sealing plate is attached with set screws to the upper surfaces of the end-plates 4 of battery blocks 2 disposed on both sides. The cooling duct sealing plate can be provided with projections on both sides at both ends and at two intermediate locations for attachment to the battery blocks 2 via set screws that pass through the projections.

In the outer case 30 described above, the lower case 31 is attached to endplates 4 via set screws (not illustrated) to attach the battery blocks 2. Set screws pass through the lower case 31 and screw into screw-holes (not illustrated) in the endplates 4 to mount the battery blocks 2 in the outer case 30. The heads of these set screws protrude out from the bottom of the lower case 31. Further, the lower case 31 is provided with projections 31B that protrude downward from both sides of the battery blocks 2. These projections 31B widen the air ducts 33 to reduce pressure losses in those ducts. The projections 31B also reinforce the lower case 31 and increase the bending strength of the lower case 31. Further, the projections 31B provided on bottom surface of the lower case 31 extend below the heads of the set screws that attach the battery blocks 2, or they extend to the same height as the heads of the set screws. For a battery system with this type of lower case 31 installed on-board a car, the projections 31B set on a car attachment plate allowing battery system weight to be distributed and supported over a wide area.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2008-281121 filed in Japan on Oct. 31, 2008, the content of which is incorporated herein by reference.

What is claimed is:

1. A battery system comprising:
a battery block that connects a plurality of battery cells having gas exhaust valves; and
an exhaust duct that is hollow in form, connects to the gas exhaust valve gas exhaust opening of each battery cell in the battery block, and exhausts gas discharged from the gas exhaust openings to the outside;
wherein the exhaust duct is made of plastic and has metal lines that extend in the lengthwise direction embedded in the plastic;

2. The battery system as cited in claim 1 wherein the battery cells are rectangular battery cells; the rectangular battery cells are stacked with their perimeter surfaces, which are provided with gas exhaust openings, aligned in a single plane to form a battery block; an exhaust duct is disposed on the perimeter surfaces, which are provided with gas exhaust openings, of the rectangular battery cells that make up the battery block; and the exhaust duct is connected to the gas exhaust opening of each rectangular battery cell.

3. The battery system as cited in claim 2 wherein a battery cell is a rectangular battery cell; and the rectangular battery cell perimeter surface, which is provided with a gas exhaust opening, has electrode terminals established at each end.

4. The battery system as cited in claim 1 wherein the exhaust duct has metal lines embedded in both opposing side-walls.

5. The battery system as cited in claim 4 wherein the exhaust duct has metal lines embedded along its perimeter.

6. The battery system as cited in claim 1 wherein the exhaust duct has embedded metal lines that are metal wires with circular cross-sections.

7. The battery system as cited in claim 1 wherein the exhaust duct has embedded metal lines that are flat-plates.

8. The battery system as cited in claim 7 wherein the flat-plate metal lines are embedded in the side-walls.

9. The battery system as cited in claim 1 wherein the exhaust duct has embedded metal lines with L-shaped cross-sections.

10. The battery system as cited in claim 9 wherein the metal lines are embedded in an exhaust duct to span across the side-walls and the upper panel.

11. The battery system as cited in claim 1 wherein the metal lines are insertion molded into the exhaust duct.

12. The battery system as cited in claim 1 wherein the metal lines are embedded in a pre-formed plastic exhaust duct by follow-up processing

13. The battery system as cited in claim 12 wherein the exhaust duct plastic is heated to melting temperature and metal lines are embedded by pressing them into the plastic exhaust duct.

14. The battery system as cited in claim 1 wherein the metal lines are connected to the ground line.

15. The battery system as cited in claim 1 wherein a metal external case is provided to house battery blocks; nuts, which mate with bolts that attach the external case, are mounted in exhaust ducts; and the metal lines are connected to those nuts to connect the metal lines to the external case.

16. The battery system as cited in claim 1 wherein battery blocks are arranged in two rows, and two rows of exhaust ducts are disposed on battery block upper surfaces.

17. The battery system as cited in claim 16 wherein a connecting duct joins the two rows of exhaust ducts.

18. The battery system as cited in claim 17 wherein the connecting duct has metal lines embedded in both opposing side-walls.

19. The battery system as cited in claim 1 wherein a circuit board is provided that connects to the battery block; and an exhaust duct with embedded metal lines is disposed between the circuit board and the battery block.

20. The battery system as cited in claim 19 wherein the metal lines are connected to the ground line.
